(19) United States
(12) Patent Application Publication
(10) Pub. No.: US 2014/0064150 A1
(43) Pub. Date: Mar. 6, 2014

(54) MST EXTENSIONS FOR FLEXIBLE AND SCALABLE VN-SEGMENT LOOP PREVENTION

(71) Applicants: Norman W. Finn, Livermore, CA (US); Munish Mehta, Freemont, CA (US); Yibin Yang, San Jose, CA (US); Chia Alex Tsai, Cupertino, CA (US)

(72) Inventors: Norman W. Finn, Livermore, CA (US); Munish Mehta, Freemont, CA (US); Yibin Yang, San Jose, CA (US); Chia Alex Tsai, Cupertino, CA (US)

(73) Assignee: CISCO TECHNOLOGY, INC., San Jose, CA (US)

(21) Appl. No.: 13/601,042

(22) Filed: Aug. 31, 2012

(51) Int. Cl. H04L 12/44

(52) U.S. Cl. 370/256

(57) ABSTRACT

In one embodiment, a first number of multiple spanning tree instances (MSTIs) are defined within a network. A second number of network segments associated with segmentation identifier (IDs) are also configured, where the first number of MSTIs is less than the second number of segmentation IDs. Segmentation ID to MSTI mappings are maintained that map each defined segmentation ID of the second number of network segments to one of the first number of MSTIs. A segmentation mapping digest is computed of the segmentation ID to MSTI mappings. Multiple spanning tree (MST) bridge protocol data units (BPDUs) are broadcast that include the digest of the segmentation ID to MSTI mappings.

### TECHNICAL FIELD

The present disclosure relates generally to computer networking, and, more particularly, to association of network segments with respective spanning trees in a computer network.

### BACKGROUND

Cloud computing service models, and in particular infrastructure as a service (IaaS) offerings are becoming increasingly prevalent. To support such offerings, providers may need to implement a large number of different network segments, for example, significantly more than 4096 network segments. In order to meet the segmentation requirements, various segmentation technologies may be utilized. However, one issue confronted with employing certain segmentation technologies is how to associate network segments with respective spanning trees of a spanning tree protocol (STP). Some potential association techniques may undesirably cause frames of different customers to be linked to the same topology, and prevent load balancing on a segment-by-segment basis. Other potential association techniques may lack scalability, since, when scaled, they may call on devices to establish and maintain a number of loop free topologies beyond their computing power. Accordingly there is a need for improved techniques.

### BRIEF DESCRIPTION OF THE DRAWINGS

The embodiments described herein may be better understood by referring to the accompanying drawings in which like reference numerals indicate identically or functionally similar elements, of which:

FIG. 1 is a hardware block diagram of an example cloud switch;

FIG. 2 is a logical block diagram of the example cloud switch of FIG. 1, showing an example internal logical shared media link (bConnect) coupled to the cloud switch domains;

FIG. 3 is a hardware block diagram of an example switch;

FIG. 4 is a schematic block diagram of an example virtual network (VN) segment tagged frame;

FIG. 5 is a logical block diagram of the example cloud switch of FIGS. 1 and 2 coupled to external servers, depicting the use of VN-segments within the cloud switch;

FIG. 6 is a portion of an example segmentation identifier (ID) to multiple spanning tree instance (MSTI) mapping table that may be maintained by cloud switch domains;

FIG. 7 is an example modified MST bridge protocol data unit (BPDU) that includes a segmentation mapping digest; and

FIG. 8 is an example sequence of steps for implementing the techniques described herein.

### DESCRIPTION OF EXAMPLE EMBODIMENTS

### Overview

According to an embodiment of the present disclosure, a first number of multiple spanning tree instances (MSTIs) are defined within a network. A second number of network segments associated with segmentation identifier (IDs) are also configured, where the first number of MSTIs is less than the second number of segmentation IDs. A memory maintains segmentation ID to MSTI mappings that map each defined segmentation ID of the second number of network segments to one of the first number of MSTIs. A processor computes a segmentation mapping digest of the segmentation ID to MSTI mappings. Multiple spanning tree (MST) bridge protocol data units (BPDUs) are broadcast that include the digest of the segmentation ID to MSTI mappings.

### Example Embodiments

A layer-2 network is collection of nodes, such as bridges and switches, interconnected by links that transports data frames using protocols associated with the Data Link Layer of the Open Systems Interconnection (OSI) Reference Model. Layer-2 networks typically provide the ability to establish dedicated point-to-point links between two nodes, as well as to provide shared media links where nodes at least appear to share a common physical media, for example, an Ethernet local area network (LAN). Layer-2 networks generally rely on hardware-based address, such as media access control (MAC) addresses from nodes' network interface cards (NICs), to decide where to forward frames.

A variety of control protocols may be implemented in layer-2 networks to manage the forwarding of frames. These protocols may include various spanning tree protocols (STPs), such as rapid spanning tree protocol (RSTP) which was standardized in IEEE Std 802.1D-2004 and multiple spanning tree protocol (MSTP) which was standardized in IEEE Std 802.1Q, as well as a variety of other protocols.

Since Layer-2 networks often include redundant links, one function of some control protocols, and in particular STPs, is to calculate one or more active network topologies that are loop-free, thereby breaking any loops that may exist in the network. For example, RSTP calculates and utilizes a single active network topology that is loop-free. In RSTP, ports of switches are assigned port roles that include Root Port role, Designated Port role, Alternate Port role and Backup Port role. They are also assigned port states that include a discarding state, a learning state, and a forwarding state. RSTP elects a single node within the network to be the Root. All ports on the Root are assigned Designated Port role. For each non-Root node, the port offering the best (e.g., lowest cost) path to the Root is assigned the Root Port role. For each non-Root node, the port offering an alternative (e.g., higher cost) path to the Root is assigned the Alternate Port role. For each LAN, the one port through which the lowest cost path to the Root is provided to the LAN is assigned the Designated Port role, while other ports through which an alternative (e.g., higher cost) path to the Root is provided may be assigned the Alternate Port role. Those ports that have been assigned the Root Port role and the Designated Port role are placed in the forwarding state. Further, ports assigned to the Alternate Port role and the Backup Port role are placed in the discarding state. In some cases, ports may be rapidly transitioned between certain states.

MSTP builds upon the basic operation of RSTP to calculate and utilize multiple active network topologies that are loop-free. In MSTP, a network is organized into regions. Within each region, MSTP establishes an Internal Spanning Tree (IST) which provides connectivity to all switches within the respective region and to the ISTs established within other regions. The IST established within each MSTP region also provides connectivity to the one Common Spanning Tree (CST) established outside of the MSTP regions. The IST of a given MST Region receives and sends BPDUs to the CST. Collectively a Common and Internal Spanning Tree (CIST) is formed.

Within each MST region, the switches establish multiple active topologies, each of which is referred to as a multiple spanning tree instance (MSTI). Each MSTI is identified by corresponding multiple spanning tree instance identifier (MSTID) and is basically a simple RSTP instance that exists only inside the respective region.

To obtain the information necessary to run STPs, such as RSTP and MSTP, switches typically exchange special messages, referred to as configuration bridge protocol data units (BPDUs). BPDUs carry information that may be used by recipients in making port role decisions and, in general, in converging upon a loop-free active topology. In MSTP switches do not send separate BPDUs for each MSTI. Instead, every MSTP BPDU carries the information needed to compute the active topology for all of the MSTIs defined within the respective region. MST BPDUs also typically carries a MST Configuration Identifier (ID) that, among other things, is used by switches to determine if they are in the same MST Region.

Layer-2 networks are increasingly being deployed in environments that stress their capabilities. To address these challenges architectures are being deployed in connection with layer-2 networks. One architecture being deployed to address issues confronted by layer-2 networks is cloud switching. Cloud switching architectures (or simply “cloud switches”) typically include a large number of individual switches (referred to herein as “leaf switches”) interconnected by a high-speed interconnect and administered collectively as virtual switches. A cloud switch, through its constituent leaf switches, may provide thousands of external ports to support demanding layer-2 networks.

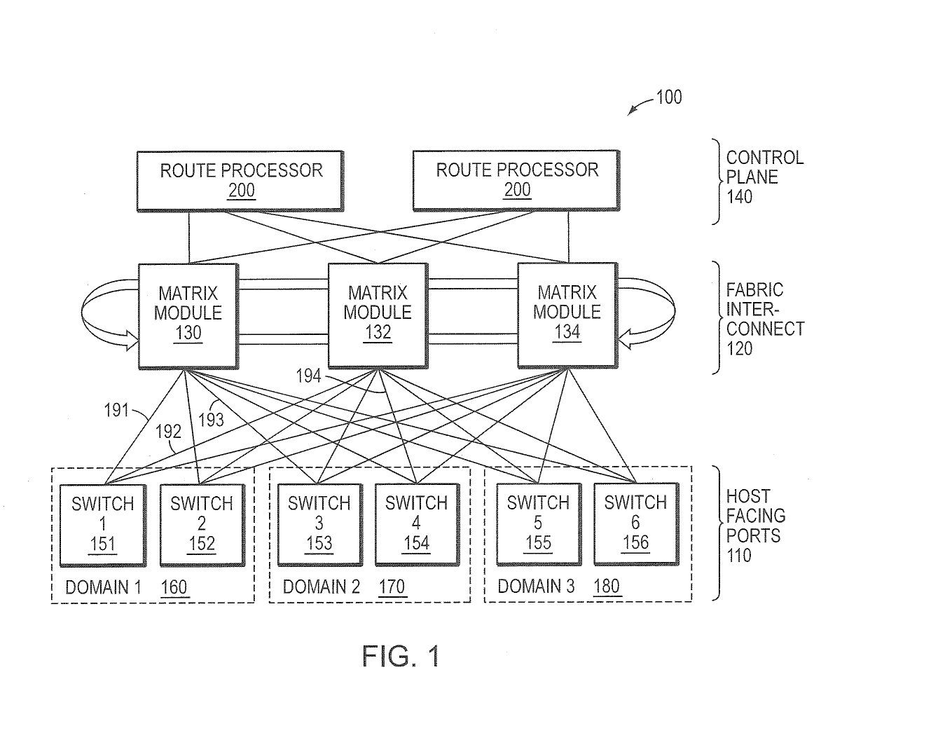

FIG. 1 is a hardware block diagram of an example cloud switch 100. The cloud switch 100 provides an array of host-facing ports 110 distributed among a plurality of leaf switches 151-156 to which external devices (e.g., hosts, external bridges, etc.) (not shown) may be coupled. The leaf switches 151-156 are coupled via a fabric interconnect 120 that includes a plurality of matrix modules 130-134 that provide pathways among the leaf switches. The matrix modules 130-134 operate under the direction of a control plane 140, which includes a plurality of route processors that control forwarding among the leaf switches 151-156. The control plane 140 may organize groups of leaf switches 151-156 into virtual switches, referred to herein as cloud switch domains. The leaf switches 151-156 of each cloud switch domain 160-180 operates in a data plane mode under the control of the control plane.

In order to managing traffic among cloud switch domains, the cloud switch 100 may implement internal logical shared media links among the cloud switch domains. These logical shared media links are referred to herein as “bConnects.” Each cloud switch domain is allowed to have only one logical port coupled to a particular bConnect. Cloud switch domains coupled to the same bConnect are permitted to pass data frames between each other through the fabric interconnect 120. Cloud switch domains that are coupled to different bConnects are prohibited from exchanging data frames with each other through the fabric interconnect 120. They may, however, exchange data frames with each other over external connections, i.e. connections external to the cloud switch 100, for example, provided by one or more external devices. Use of bConnects prevents loops within the cloud switch 100. However, a separate loop prevention mechanism is typically still utilized to prevent external loops, i.e. loops through external devices. Accordingly, a STP is typically still executed to break these external loops

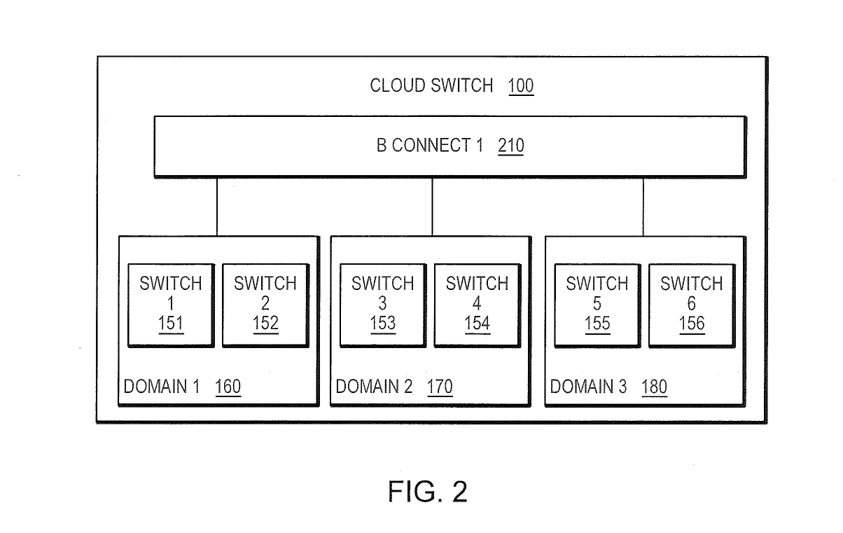

FIG. 2 is a logical block diagram of the example cloud switch 100 of FIG. 1, showing an example internal logical shared media link (bConnect) 210 coupled to the cloud switch domains 160-180. Since the first cloud switch domain 160, the second cloud switch domain 170, and the third cloud switch domain 180 are coupled to a first bConnect 210, the first and second leaf switches 151, 152 of first cloud switch domain 160 are permitted to exchange data frames with the third and fourth leaf switches 153, 154 of the second cloud switch domain 170 and the fifth and sixth leaf switches 153, 154 of the third cloud switch domain 180, by virtue of their attachment to a common bConnect.

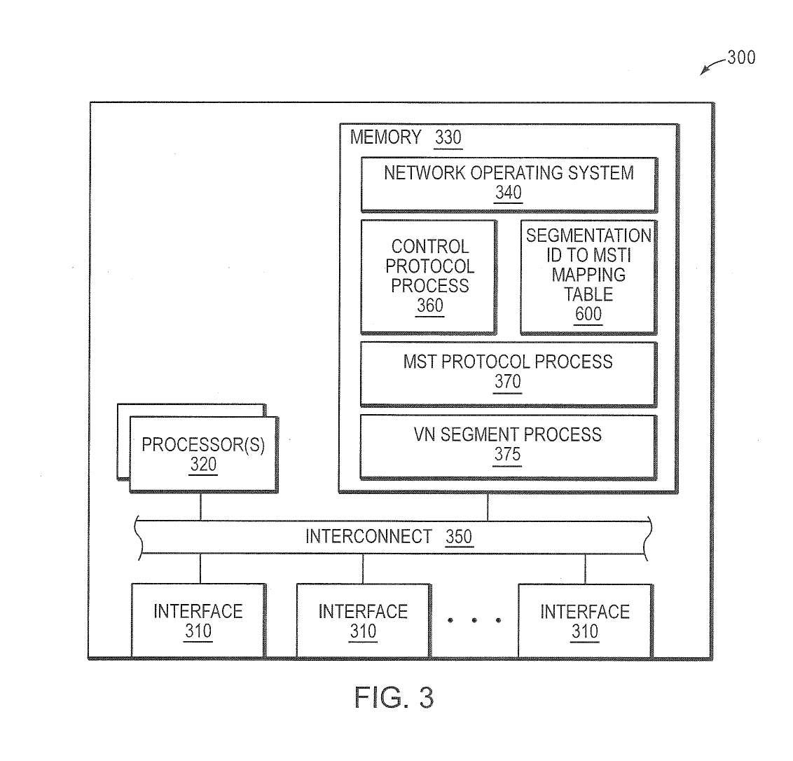

FIG. 3 is a hardware block diagram of an example switch 300. The switch 300 may be functionally equivalent to one of the cloud switch domain 160-180 of FIGS. 1 and 2, and represent components included in such domains (for example, dispersed across multiple cloud switches). The switch 300 includes a plurality of interfaces 310, one or more processors 320, and a memory 330 coupled by an interconnect structure 350. The interfaces 310 contain mechanical, electrical, and signaling circuitry for connecting to other devices. The interfaces 310 may include host facing ports for connecting to external devices, such as hosts. The interfaces may also include ports for coupling to internal components of the cloud switch, for example, to matrix modules. The memory 330 includes a plurality of storage locations for storing software and data structures. The one or more processors 320 include logic configured to execute the software and manipulate data from the data structures. The software may include a network operating system 340, as well as a number of protocol processes, including a MST protocol process 370 and a virtual network (VN) segment process 375, the operation of which are discussed below. The data structures may include various tables, including a segmentation ID to MSTI mapping table 600, the operation of which is also discussed below.

Cloud switches are often called upon to support a cloud computing service model, where a customer is supplied on-demand access to a shared pool of configurable computing resources that can be rapidly provisioned and released. In particular, cloud switches may be suited for providing the cloud offering commonly referred to as infrastructure as a service (IaaS). In IaaS, customers are provided with network, computing and storage resources, on which they are able to deploy and run arbitrary software, including desired operating systems and applications. IaaS offerings generally deploy software within a structure referred to as a virtual private cloud. Applications are deployed within the virtual private cloud using a container referred to as a virtual datacenter. A virtual datacenter is generally a collection of virtual machines (VMs) interconnected using network segments. In this context, a network segment is a partition of infrastructure within which resources may be shared and upon which network communication policies may be enforced. In a configuration with many customers and many virtual datacenter, there may be a need for a large number of different network segments, for example, significantly more than 4096 network segments.

In order to meet the segmentation requirements of such configurations, virtual network (VN) segment technology may be utilized. With VN-segment technology, segmentation is implemented through use of a segmentation ID. In one implementation, the segmentation ID is a 24-bit ID, formed from the concatenation of two 12-bit VLAN IDs provided by two IEEE 802.1Q VLAN tags. Unlike certain other segmentation techniques, such as QinQ, in a VN-segment paradigm the entire segmentation ID may be used for each forwarding decision, rather than a single constituent VLAN identifier. In such manner, certain efficiencies may be achieved.

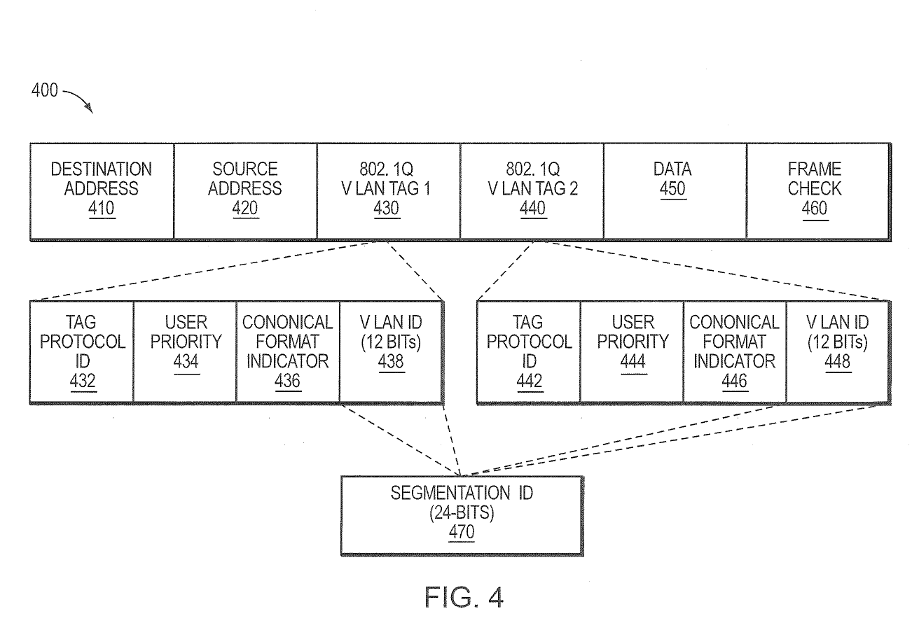

FIG. 4 is a schematic block diagram of an example VN-segment tagged frame 400. The example frame 400 includes a destination address field 410, a source address field 420, a first IEEE 802.1Q VLAN tag 430, and a second IEEE 802.1Q VLAN tag 440, prepended onto a data portion 450. The data portion 450 may include additional headers and tags, along with the actual message data. A frame check field 460 terminates the frame, and includes checksum characters for error detection purposes. Each IEEE 802.1Q VLAN tag 430, 440 may include a respective tag protocol ID field 432, 442, user priority field 434, 444, canonical format indicator field 436, 446, and VLAN ID field 438, 448. As discussed above, the bits of the VLAN ID fields 438, 448 may be combined (e.g., concatenated) to form a segmentation ID 470 used to identify a network segment according to a VN-segment technique. It should be understood that different frame formats, having different and/or additional fields, headers, and tags, may be employed with VN-segment technology. These various fields, headers, and tags may be used to store the segmentation ID in a variety of manners. For example, in some implementations, the segmentation ID may be held in a single dedicated field of the frame 400.

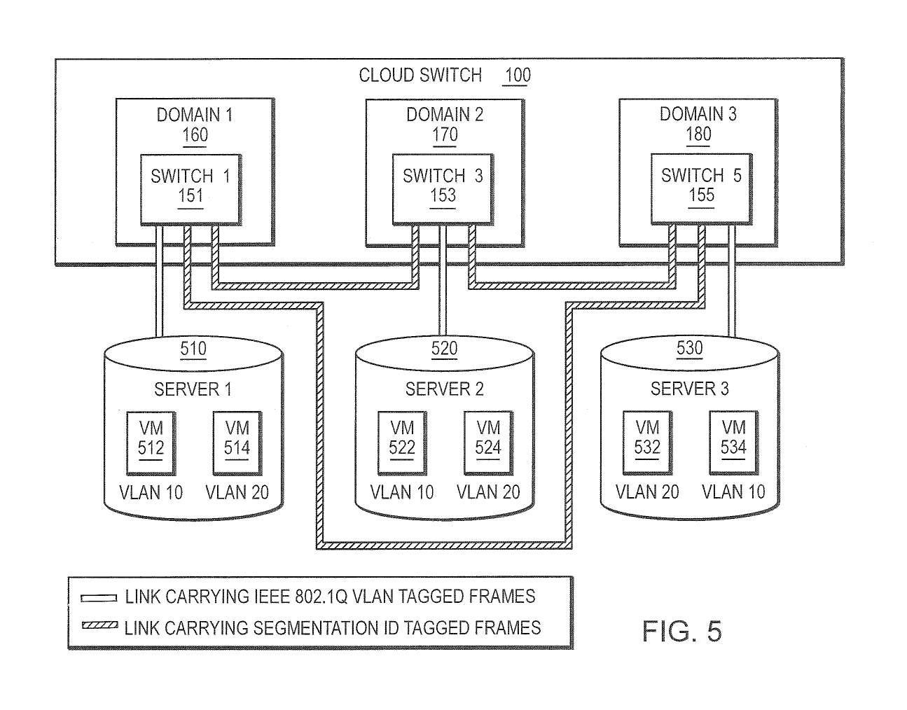

FIG. 5 is a logical block diagram of the example cloud switch 100 of FIGS. 1 and 2 coupled to external servers 510, 520, 530, depicting the use of VN-segments within the cloud switch. Certain elements of FIGS. 1 and 2, such as the logical shared media link (bConnect) 210, and additional leaf switches 152, 154, 156, have been omitted for simplicity. The servers 510, 520, 530 may implement VMs 512, 514, 522, 524, 532, 534 of a cloud computing service model. Each VM may be associated with a VLAN having a VLAN ID. For example, the first server 510 may implement a first VM 512 associated with VLAN 10 and a second VM 534 associated with VLAN 20, the second server 520 may implement a first VM 522 associated with VLAN 10 and a second VM 522 associated with VLAN 20, and the third server 530 may implement a first VM 532 associated with VLAN 20 and a second VM 514 associated with VLAN 10. External to the cloud switch 100, frames from the servers 510, 520, 530 may include single IEEE 802.1Q VLAN tags, identifying the respective VLANs to which the frames are associated. Upon arrival at leaf switches 151, 153, 155 of cloud switch domains 160, 170, 180, for inter domain communication, an additional IEEE 802.1Q VLAN tag may be added to the frames, to form a segmentation ID tagged frame, as shown above in FIG. 4.

One issue confronted with employing VN-segment technology is how to associate segments with respective spanning trees. While one may attempt to associate spanning trees, for example MST instances, with one of the constituent VLAN IDs (e.g., the VLAN ID of the outer IEEE 802.1Q VLAN tag 430), such an approach has a number of shortcomings. In VN-segment technology, the segmentation ID 470 is a flat structure, with no limitation on how customers are allocated segmentation IDs. Using one of the constituent VLAN IDs (e.g., the VLAN ID of the outer IEEE 802.1Q VLAN tag 430) would cause all network segments whose segmentation ID incorporates the VLAN ID to use the same loop-free topology. Due to the flat nature of the segmentation IDs, this may undesirably lead to frames of different customers being linked to the same topology. In generally, load balancing would not be possible on a segment-by-segment basis.

Further, while one may attempt to run RSTP per segment, such that each segment has a unique RSTP loop free topology, such an approach lacks scalability. In a typical cloud computing service model, there may be thousands or even hundreds of thousands of customers, leading to potentially millions of network segments. Many switches may lack the computing power necessary to establish and maintain an individual RSTP loop free topology for each of these network segments.

In one embodiment of the present disclosure, network segments are mapped to a limited number of loop free topologies in a flexible and scalable manner. Each domain of a cloud switch may execute a MST protocol, using MST protocol process 370, to define a first number of MSTIs. Each cloud switch domain executes a VN-segment process 375 to configure a second number of network segments that are each associated with respective segmentation IDs. A segmentation ID to MSTI mapping table 600 is maintained, which maps each defined segmentation ID of the second number of network segments to one of the first number of MSTIs. In typically implementations, the first number of MSTIs is significantly less than the second number of segmentation IDs, such that multiple segments share at least some of the MSTIs.

Each cloud switch domain may compute a digest of the domain's segmentation ID to MSTI mapping table (herein referred to as a “segmentation mapping digest”), and broadcast modified MST BPDUs that include the segmentation mapping digest. Further, each cloud switch domain receives modified MST BPDUs from other cloud switch domain. Upon receipt of a modified MST BPDU from a particular other cloud switch domain, the contained segmentation mapping digest is compared with the digest of the local segmentation ID to MSTI mapping table. If there is a match, the particular other cloud switch domain is determined to belong to the same MST region as the local cloud switch domain. Traffic exchanged with the particular other cloud switch domain may be load balanced among the MSTIs according to the mappings in the segmentation ID to MSTI mapping table 600. For each port, per-segment blocking logic may be configured based on the spanning tree port states of the MSTI used for the corresponding segment. Conversely, if there is no match, the particular other cloud switch domain is determined to belong to a different MST region than the local domain. Traffic exchanged with the particular other cloud switch domain is caused to utilize the CIST defined by the MST protocol, without load balancing.

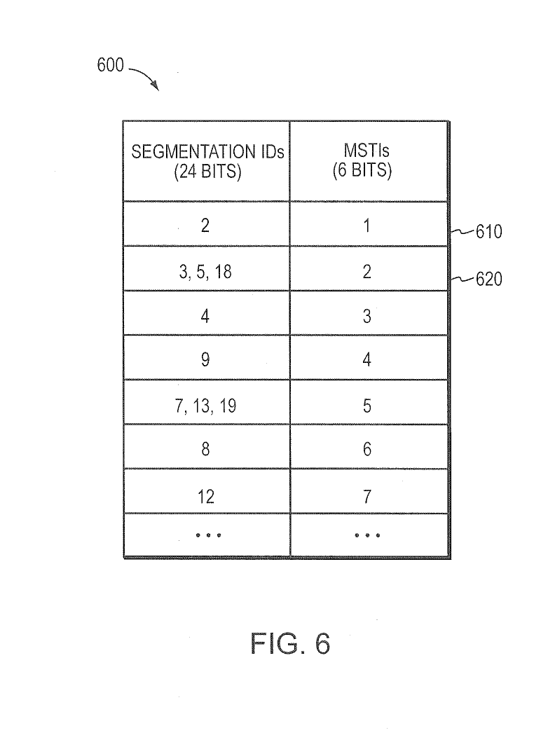

FIG. 6 is a portion of an example segmentation ID to MSTI mapping table 600 that may be maintained by cloud switch domains. Each entry of the table 600 may include one or more segmentation IDs (e.g., having 24 bits) mapped to a particular MSTI (e.g., having 6 bits). For example, a first entry 610 may map network segment 2 to instance 1, while a second entry 620 may map network segments 3, 5 and 18 to instance 2. The segments may be mapped to the MSTIs based upon bandwidth, port costs, reliability, bridge ID, or other factors. For example, in a bandwidth-based mapping, attempts may be made to equalize the bandwidth demands incident on each MSTI. For instance, a particular MSTI may have a single network segment with large bandwidth demands mapped to it, while another MSTI may have a multitude of network segment with small bandwidth demands mapped to it, in efforts to equalize the bandwidth demands. In general, the segmentation ID to MSTI mapping table 600 may map a second number of network segments (e.g., up to 16,777,216 if a 24-bit segmentation ID is employed) to a first number of first number of MSTIs (e.g., 64 minus several reserved MSTIs if a 6-bit ID is employed) based on any of a variety of factors that promote load balancing or other objectives.

A cryptographic hash may be applied to the segmentation ID to MSTI mapping table 600 to produce a digest. In one embodiment, due to the potentially large size of the segmentation ID to MSTI mapping table 600, in efforts to reduce the chance of collisions, a hash-based message authentication code message-secure hash algorithm 256 (HMAC-SHA256) algorithm may be employed to generate a 256 bit value. Alternatively, a traditional hash-based message authentication code message-digest 5 (HMAC-MD5) algorithm may be employed to generate a 128 bit value. It should be understood that a variety of other digest generating algorithm may also be employed.

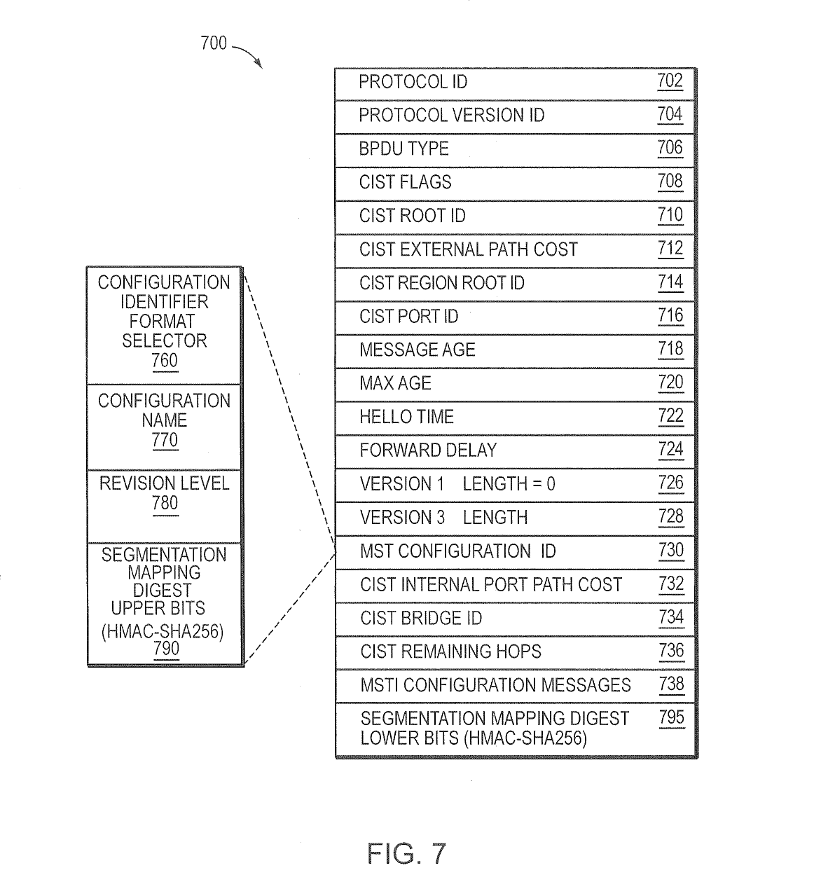

FIG. 7 is an example modified MST BPDU 700 that includes a segmentation mapping digest. The modified MST BPDU 700 includes a number of fields 702-738 traditionally found in MST BPDUs, including a MST configuration ID 730. In one implementation, the MST configuration ID 730 may be modified, and an additional field added after the MSTI configuration messages 738. The MST configuration ID 730 traditionally includes a configuration identifier format selector 760, a configuration name 770, a revision level 780, and a configuration digest. The configuration identifier format selector 760 may be loaded with a predetermined value (e.g., 00000001) to indicate a new encoding of the MST configuration ID 730. The traditional configuration digest may be repurposed to be a segmentation mapping digest upper bits field 790, which holds, for example, the upper 128-bits of a 256-bit digest generated by a HMAC-SHA256 algorithm. A new dedicated field, referred to as a segmentation mapping digest lower bits field 795, may be added to hold, for example, the lower 128-bits of the 256-bit digest generated by the HMAC-SHA256 algorithm, such that collectively between the two fields the entire digest is stored. It should be understood that a variety of other storage formats may alternatively be employed within the MST BPDU 700, involving the repurposing of existing fields and/or the addition of new fields, with the segmentation mapping digest stored in one field, or across multiple fields. Accordingly, the above discussed arrangement is but one example.

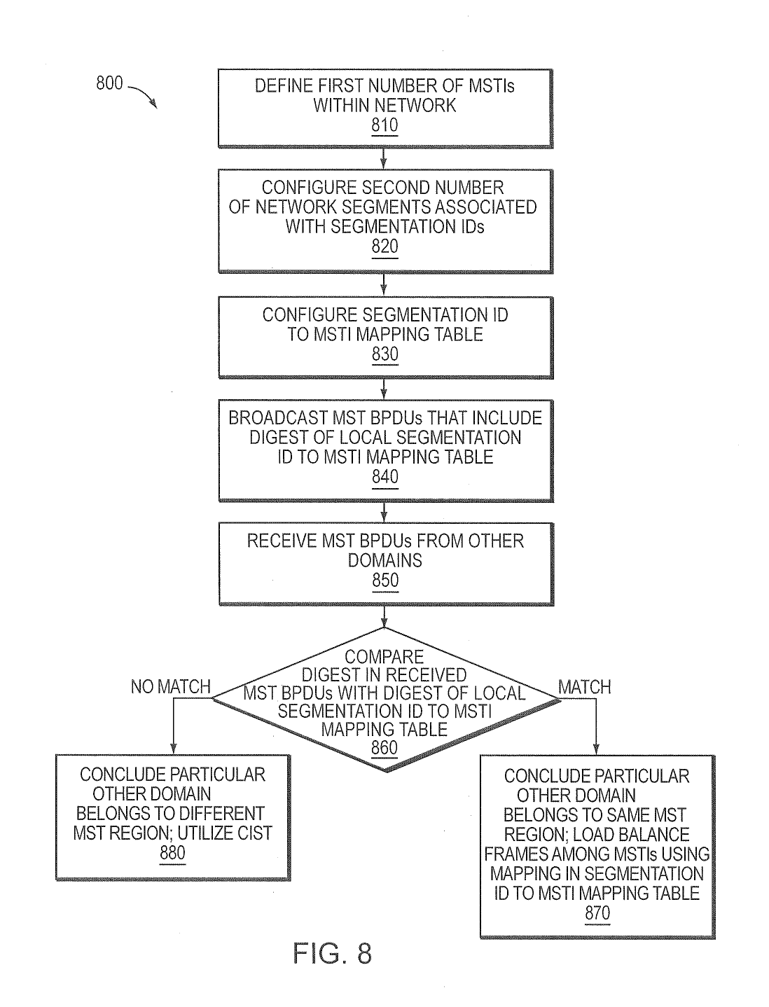

FIG. 8 is an example sequence of steps 800 for implementing the techniques described herein. At step 810, the MST protocol process 370 of a cloud switch domain defines a first number of MSTIs within the network, for example, that break external loops. At step 820, the VN-segment process 375 of the cloud switch domain configures a second number of network segments that are each associated with respective segmentation IDs. At step 830, a segmentation ID to MSTI mapping table 600 is configured, which maps each defined segmentation ID of the second number of network segments to one of the first number of MSTIs. At step 840, the MST protocol process 370 of the cloud switch domain computes a digest of the domain's segmentation ID to MSTI mapping table 600 (a “segmentation mapping digest”), and broadcasts modified MST BPDUs that include the segmentation mapping digest. At step 850, the cloud switch domain receives modified MST BPDUs from other cloud switch domains. At step 860, the MST protocol process 370 compares the contained segmentation mapping digest with the digest of the local segmentation ID to MSTI mapping table 600. If there is a match for a particular MST BPDU, execution proceeds to step 870, where the particular other cloud switch domain associated with that BPDU is concluded to belong to the same MST region as the domain, and traffic exchanged with the particular other cloud switch domain is balanced among the MSTIs according to the mappings in the segmentation ID to MSTI mapping table 600. If there is no match for a particular MST BPDU, execution proceeds to step 880, where the particular other cloud switch domain associated with that BPDU is determined to belong to a different MST region than the local domain, and traffic exchanged with the particular other cloud switch domain is caused to utilize the CIST defined by the MST protocol, without any load balancing.

In summary, the present disclosure describes embodiments that flexibly and scalably map network segments to a limited number of loop free topologies, in part by configuring segmentation ID to MSTI mapping tables and distributing digests thereof. It should be understood that various adaptations and modifications may be readily made.

For example, while it is described above that certain operations are implemented in cloud switch domains, it should be understood that the techniques may be implemented in a variety of other types of network structures or nodes, which may not be part of a cloud switch. These network structures or nodes may be part of another type of data center architecture that utilizes a large number of network segments, or some other type of architecture.

Further, while it is described above that the segmentation ID is a 24-bit ID used with VN-segment technology, formed from the concatenation of two 12-bit VLAN IDs provided by two IEEE 802.1Q VLAN tags, it should be understood that the segmentation ID may be used with other technologies, and composed of a different number of bits or characters. For example, the segmentation ID may be 36-bit ID, formed, for example from the concatenation of three 12-bit VLAN IDs provided by three IEEE 802.1Q VLAN tags. Alternatively, the segmentation ID may be 36-bit ID stored in a single dedicated field of frames. Alternatively, the segmentation ID may be string of characters, stored in some manner within frames.

Still further, it should be understood that at least some of the above-described embodiments may be implemented in software, in hardware, or a combination thereof. A software implementation may include computer-executable instructions stored in a non-transitory computer-readable medium, such as a volatile or persistent memory, a hard-disk, a compact disk (CD), or other tangible medium. A hardware implementation may include configured processors, logic circuits, application specific integrated circuits, and/or other types of hardware components. Further, a combined software/hardware implementation may include both computer-executable instructions stored in a non-transitory computer-readable medium, as well as one or more hardware components, for example, processors, memories, etc. The above descriptions are meant to be taken only by way of example. It is the object of the appended claims to cover all such variations and modifications as come within the true spirit and scope of the embodiments herein.

What is claimed is:

1. A method comprising:
defining a first number of multiple spanning tree instances (MSTIs) within a network;
configuring a second number of network segments associated with segmentation identifier (IDs), wherein the first number of MSTIs is less than the second number of segmentation IDs;
maintaining, in a memory, segmentation ID to MSTI mappings that map each defined segmentation ID of the second number of network segments to one of the first number of MSTIs;
computing, by a processor, a segmentation mapping digest of the segmentation ID to MSTI mappings; and
broadcasting multiple spanning tree (MST) bridge protocol data units (BPDUs) that include the digest of the segmentation ID to MSTI mappings.

2. The method of claim 1, further comprising:
receiving MST BPDUs from a particular other domain; and
comparing a segmentation mapping digest in the received MST BPDUs from the particular other domain with the computed segmentation mapping digest.

3. The method of claim 2, further comprising:
when the segmentation mapping digest in the received MST BPDUs matches the computed segmentation mapping digest, concluding the particular other domain belongs to a same MST region; and
in response to concluding the particular other domain belongs to the same MST region, load balancing frames among MSTIs using the segmentation ID to MSTI mappings.

4. The method of claim 2, further comprising:
when the segmentation mapping digest in the received MST BPDUs does not match the computed segmentation mapping digest, concluding the particular other domain belongs to a different MST region; and
in response to concluding the particular other domain belongs to a different MST region, utilizing a common and internal spanning tree (CIST).

5. The method of claim 1, wherein the segmentation ID is formed from a concatenation of at least two virtual local area network (VLAN) IDs.

6. The method of claim 5, wherein the entire segmentation ID formed from the concatenation of at least two VLAN IDs is used for forwarding decisions.

7. The method of claim 1, wherein the segmentation ID to MSTI mappings are stored in a segmentation ID to MSTI mapping table, and the digest of the segmentation ID to MSTI mappings is a digest of the segmentation ID to MSTI mapping table.

8. The method of claim 7, wherein the computing further comprises:
applying a hash-based message authentication code message-secure hash algorithm 256 (HMAC-SHA256) to the segmentation ID to MSTI mapping table to generate the digest of the segmentation ID to MSTI mapping table.

9. The method of claim 7, wherein the broadcasting further comprises:
storing at least a first portion of the digest of the segmentation ID to MSTI mapping table in a MST configuration ID of the BPDUs.

10. The method of claim 9, wherein storing further comprises:
storing a second portion of the digest of the segmentation ID to MSTI mapping table in a dedicated field added to the BPDUs.

11. The method of claim 1, wherein the processor and memory are of a cloud switch domain of a cloud switch.

12. An apparatus comprising:
one or more host facing ports;
one or more processors configured to execute one or more software processes and one or more data structures; and
one or more memories configured to store software processes and data structure including
a multiple spanning tree (MST) protocol process that is configured to define a first number of multiple spanning tree instances (MSTIs) within a network,
a virtual network (VN) process that is configured to manage a second number of network segments associated with segmentation identifiers (IDs), wherein the first number of MSTIs is less than the second number of segmentation IDs, and
a segmentation ID to MSTI mapping table that maps segmentation IDs to MSTIs,
wherein the MST protocol process is further configured to broadcast MST bridge protocol data units (BPDUs) on the host facing ports that include a digest of the segmentation ID to MSTI mappings.

13. The apparatus of claim 12, wherein the MST protocol process is further configured to compare a segmentation mapping digest in MST BPDUs received on a host facing port from a particular other apparatus with the segmentation mapping digest at the apparatus.

14. The apparatus of claim 13, wherein the MST protocol process is further configured to, when the segmentation mapping digest in the received MST BPDUs matches the segmentation mapping digest at the apparatus, conclude the particular other apparatus belongs to a same MST region as the apparatus, and, in response, load balance frames among MSTIs using the segmentation ID to MSTI mapping table.

15. The apparatus of claim 13, wherein the MST protocol process is further configured to, when the segmentation mapping digest in the received MST BPDUs does not match the segmentation mapping digest at the apparatus, conclude the particular other apparatus belongs to a different MST region than the apparatus, and in response, utilize a Common and Internal Spanning Tree (CIST).

16. The apparatus of claim 12, wherein the segmentation ID is formed from a concatenation of at least two virtual local area network (VLAN) IDs.

17. The apparatus of claim 12, wherein the entire segmentation ID is used for forwarding decisions for frames.

18. The apparatus of claim 12, wherein the digest is a hash-based message authentication code message-secure hash algorithm 256 (HMAC-SHA256) cryptographic hash.

19. The apparatus of claim 12, wherein the apparatus is a cloud switch domain of a cloud switch.

20. A non-transitory computer-readable medium having software encoded thereon, the software when executed operable to:
define a first number of multiple spanning tree instances (MSTIs) within a network;
configure a second number of network segments associated with segmentation identifier (IDs), wherein the first number of MSTIs is less than the second number of segmentation IDs;
maintain segmentation ID to MSTI mappings that map each defined segmentation ID of the second number of network segments to one of the first number of MSTIs;
compute a segmentation mapping digest of the segmentation ID to MSTI mappings; and
broadcast multiple spanning tree (MST) bridge protocol data units (BPDUs) that include the digest of the segmentation ID to MSTI mappings.
